(19) United States
(12) Patent Application Publication
(10) Pub. No.: US 2026/0236283 A1
(43) Pub. Date: Aug. 13, 2026

(54) Analog Computer Simulation System and Method of Use

(71) Applicant: Alexander Soiguine, Aliso Viejo, CA (US)

(72) Inventor: Alexander Soiguine, Aliso Viejo, CA (US)

(21) Appl. No.: 19/342,754

(22) Filed: Sep. 29, 2025

Related U.S. Application Data
(60) Provisional application No. 63/757,857, filed on Feb. 13, 2025.

(51) Int. Cl. G06F 9/455; G06F 8/41

(52) U.S. Cl. CPC G06F 9/455; G06F 8/41

(57) ABSTRACT

An analog supercomputer (i.e., analog computer) simulator system that executes large-scale data-intensive applications using geometric algebra (GA) in place of qubit-based quantum computation is disclosed. An applications module receives workloads, partitions them into parallel tasks, and manages data preprocessing for GA transformation. A GA engine reformulates tasks into a geometric algebra intermediate representation (GA-IR) with multivector elements, models computational states as operators acting on observables derived from Maxwell-equation formulations and compiles the GA-IR into GPU-executable kernels. An analog-simulation layer emulates continuous-time analog computation in a digital GPU environment, distributing execution across multiple GPU threads. An execution platform, including at least one CPU and at least one integrated GPU within a system-on-chip, executes the kernels efficiently without qubit entanglement. The system also supports concurrent execution of multiple prioritized workloads with GPU stream isolation, independently aggregating and returning results.

### CROSS-REFERENCE TO RELATED APPLICATION

The present application claims priority to, and the benefit of, U.S. Provisional Application No. 63/757,857 which was filed on Feb. 13, 2025, and is incorporated herein by reference in its entirety.

### FIELD OF THE INVENTION

The present invention generally relates to high-performance computing systems. More specifically, the present invention relates to a software-implemented analog supercomputer (i.e., analog computer) simulator configured to perform large-scale, data-intensive computation using geometric algebra (GA) in place of qubit-based quantum processing. The invention comprises an applications layer for receiving and partitioning workloads, a geometric algebra engine for reformulating computational tasks into a geometric algebra intermediate representation (GA-IR) with multivector elements, and an analog-simulation layer for emulating continuous-time analog computation on multithread graphic processing unit (GPU) platforms. The system is optimized for execution on system-on-chip (SoC) architectures, such as ARM processors with integrated GPUs, enabling energy-efficient and cost-effective operation. Accordingly, the present disclosure makes specific reference thereto. Nonetheless, it is to be appreciated that aspects of the present invention are also equally applicable to other like applications, devices, and methods of manufacture.

### BACKGROUND

By way of background, entanglement-based implementations are used in quantum computing and qubits are manipulated to represent and process information. While theoretically promising, the entanglement-based implementations have proven extremely challenging in practice. Maintaining qubit entanglement over time requires highly specialized hardware operating under extreme environmental controls, and even then, qubit stability and noise issues remain unresolved. Over the past decade, billions of dollars have been invested globally in developing entanglement-based quantum computers, yet no commercially viable system has emerged. The substantial financial and human resources devoted to this path have yielded limited progress toward practical large-scale computation. Individuals desire a fundamentally different system that enables effective large-scale simulation without qubit entanglement, thereby avoiding the continued waste of resources on an impractical technological path.

Therefore, there exists a long-felt need in the art for a computing system that delivers the promised advantages of quantum computing without relying on qubit entanglement. There is a long-standing need for a simulation-based approach capable of executing large-scale, data-intensive applications efficiently using widely available, energy-efficient hardware. Further, there is a need in the art for a computing platform that replaces conventional complex-number processing with geometrically feasible multivector operations. Additionally, there exists a need for a simulator solution that uses GPU multithreading and system-on-chip (SoC) architectures to emulate analog computation at scale. Finally, there is a long-felt need in the art for a multi-workload processing environment for executing concurrent tasks without interference, offering a way for large computing companies to save money.

The subject matter disclosed and claimed herein, in one embodiment, comprises a software-implemented analog supercomputer (i.e., analog computer) simulator that uses geometric algebra (GA) to process workloads in place of qubit-based computation. The simulator includes an applications layer configured to receive user jobs, partition the jobs into parallel tasks, and manage dataset preprocessing for GA transformation. A geometric algebra engine reformulates each task into a geometric algebra intermediate representation (GA-IR) comprising multivector elements, models computational states as operators acting on observables derived from Maxwell-equation formulations and compiles the GA-IR into GPU-executable kernels. An analog-simulation layer emulates continuous-time analog computation using discretized steps optimized for GPU execution, distributing the workload across thousands of GPU threads. The system operates on ARM-based SoCs with integrated GPUs, executing GA kernels with high throughput and low energy consumption.

In one embodiment, the simulator includes a multi-workload execution capability in which workloads from different users or applications are prioritized based on available CPU/GPU resources, energy budgets, and deadlines.

In this manner, the GA-based analog supercomputer (i.e., analog computer) simulator of the present invention addresses longstanding shortcomings in conventional quantum computing by delivering scalable, stable, and interpretable computation without qubit entanglement. The invention enables execution of large-scale applications with significantly reduced energy demands and manufacturing costs, while providing a flexible environment for single or concurrent workload processing. The system integrates geometric algebra computation, analog simulation emulation, GPU multithreading, and workload optimization into a single software platform, offering a high-performance, economically viable, and environmentally responsible computing solution.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an analog supercomputer (i.e., analog computer) simulator system comprises an applications module configured to receive a workload from a user or application, to partition the workload into a plurality of parallel tasks. The system further comprises a geometric algebra (GA) engine configured to reformulate each of the plurality of parallel tasks from a complex-number or vector/matrix representation into a geometric algebra intermediate representation (GA-IR) comprising multivector elements. The system additionally includes an analog-simulation layer configured to emulate continuous-time analog computation in a digital GPU environment by executing the GPU-executable kernels and to distribute execution of the GPU-executable kernels across a plurality of GPU threads. An execution platform comprising at least one CPU and at least one GPU integrated within a system-on-chip (SoC) is configured to execute the GPU-executable kernels.

In another embodiment, the GA engine is also configured to model computational states as operators acting on observables derived from Maxwell-equation formulations and to compile the GA-IR into GPU-executable kernels optimized for multithread parallelism

In one embodiment, the analog supercomputer (i.e., analog computer) simulator system is further configured to execute the workload without qubit entanglement, thereby reducing energy consumption and eliminating the need for custom processor fabrication.

In yet another embodiment, a computer-implemented method for simulating analog computation using geometric algebra comprises receiving, by an applications module, a workload from a user or application. The method further comprises partitioning, by the applications module, the workload into a plurality of tasks. Each of the plurality of tasks is translated, by a geometric algebra engine, into a geometric algebra intermediate representation (GA-IR) comprising multivector elements and operators acting on observables derived from Maxwell-equation formulations. The method also comprises optimizing, by the geometric algebra engine, the GA-IR into a set of GPU-executable kernels. The set of GPU-executable kernels is executed, by an analog-simulation layer, in a digital GPU environment configured to emulate continuous-time analog computation. Execution of the set of GPU-executable kernels is distributed across a plurality of GPU threads.

In still another embodiment, a method for concurrent execution of multiple workloads in an analog supercomputer (i.e., analog computer) simulator comprises receiving, by an applications module, a plurality of workloads from a plurality of users or applications, each workload having associated computational requirements. The method further comprises prioritizing, by the applications module, the plurality of workloads based on at least one of available CPU and GPU resources, energy budgets, or execution deadlines. The prioritized workloads are executed, by an analog-simulation layer, in an interleaved fashion within a GPU-based analog-simulation loop using GPU stream isolation to prevent interference between workloads. The method also comprises aggregating, by the analog-simulation layer, results of the execution independently for each of the plurality of workloads.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block-diagram showing architecture of the analog supercomputer (i.e., analog computer) simulation software system in accordance with the disclosed architecture;

FIG. 2 illustrates a flowchart depicting a process for processing a workload using the GA-based analog supercomputer (i.e., analog computer) simulator software of the present invention in accordance with the disclosed architecture; and

FIG. 3 illustrates a flowchart showing a process for executing multiple workloads concurrently within the GA-based analog supercomputer (i.e., analog computer) simulator system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a computing system that delivers the promised advantages of quantum computing without relying on qubit entanglement. There is a long-standing need for a simulation-based approach capable of executing large-scale, data-intensive applications efficiently using widely available, energy-efficient hardware. Further, there is a need in the art for a computing platform that replaces conventional complex-number processing with geometrically feasible multivector operations. Additionally, there exists a need for a simulator solution that uses GPU multithreading and system-on-chip (SoC) architectures to emulate analog computation at scale. Finally, there is a long-felt need in the art for a multi-workload processing environment for executing concurrent tasks without interference, offering a way for large computing companies to save money.

The present invention, in one exemplary embodiment, is a computer-implemented method for simulating analog computation using geometric algebra and comprises receiving, by an applications module, a workload from a user or application. The method further comprises partitioning, by the applications module, the workload into a plurality of tasks. Each of the plurality of tasks is translated, by a geometric algebra engine, into a geometric algebra intermediate representation (GA-IR) comprising multivector elements and operators acting on observables derived from Maxwell-equation formulations. The method also comprises optimizing, by the geometric algebra engine, the GA-IR into a set of GPU-executable kernels. The set of GPU-executable kernels is executed, by an analog-simulation layer, in a digital GPU environment configured to emulate continuous-time analog computation. Execution of the set of GPU-executable kernels is distributed across a plurality of GPU threads.

Reference will now be made in detail to the present preferred embodiments of the invention, examples of which are illustrated in the accompanying drawings. Wherever possible, the same reference numerals are used in the drawings and the description to refer to the same or like parts.

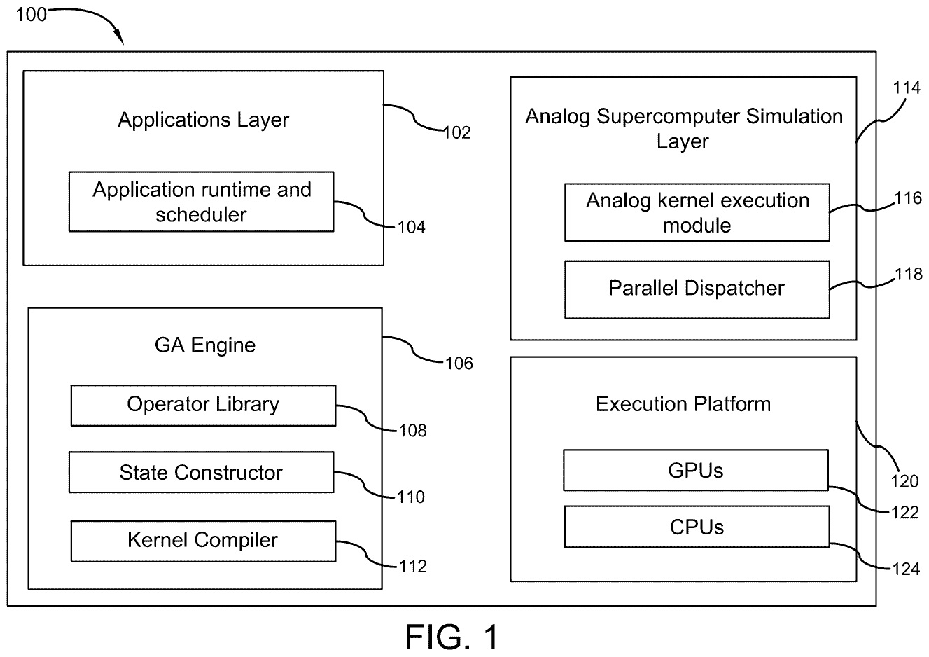

Referring initially to the drawings, FIG. 1 illustrates a block-diagram showing architecture of the analog supercomputer (i.e., analog computer) simulation software system in accordance with the disclosed architecture. The analog supercomputer (i.e., analog computer) simulator system 100 of the present invention is designed to provide a cost-effective alternative to traditional entanglement-based quantum computing. The software system 100 uses a plurality of geometric algebra processes to model computation instead of using qubits. The software system 100 provides a simulation environment capable of running large-scale data-intensive applications efficiently, with significantly lower energy and manufacturing demands.

More specifically, the software system 100 includes an applications layer/module 102 which provides user-facing functionality and orchestration for running multiple large-data workloads concurrently. The applications layer 102 includes an application runtime and scheduler 104 configured to receive user jobs, partition the jobs into a plurality of parallel tasks, and assign priorities and quotas. The applications layer 102 is workload agnostic and manages dataset ingress/egress and stream adaptation of the data in the software system 100. Specifically, input or ingress datasets are pre-processed, structured, and queued for geometric algebra (GA) transformation.

Once tasks are defined, tasks move to a geometric algebra (GA) engine 106, where the computational model is reformulated from traditional floating-point or complex-number mathematics into geometric algebra representations (geometric algebra intermediate representation). The geometric algebra (GA) engine 106 is configured to replace conventional complex-number formalisms with geometrically feasible multivector elements. The geometric algebra engine 106 includes an operator library 108 which includes geometric, inner, and outer products, and a state constructor 110 is configured to model “states” as operators acting on observables derived from Maxwell-equation formulations. The GA operators are applied to create computational “states” that are mathematically robust and geometrically interpretable. A GA kernel compiler 112 lowers GA expressions into GPU-executable kernels which are optimized for multithread parallelism. The kernel compiler 112 selects parallelization strategies according to capabilities available of the system-on-chip (SoC) (ARM-processor platforms with integrated GPUs) on which the software system 100 runs. It should be noted that the geometric algebra (GA) engine 106 replaces fragile qubit entanglement logic with stable, noise-free GA operations.

In conventional computational physics and quantum mechanics, complex numbers are used extensively, but they often lack direct geometric interpretability and can introduce unnecessary abstraction layers. By substituting into GA multivectors by the geometric algebra (GA) engine 106, the software system 100 enables computations to be represented in the GA multivectors forms that have a clear geometric meaning, aligning mathematical models more closely with the physical realities they simulate.

An analog-supercomputer (i.e., analog computer) simulation layer 114 is configured to emulate continuous-time analog computation using discretized steps optimized for GPU execution. The compiled GA kernels from the geometric algebra (GA) engine 106 are passed to the analog-simulation layer 114, and the software system 100 behaves like an analog computer. An analog kernel execution module 116 processes the GA kernels to emulate continuous mathematical systems and a parallel dispatcher 118 distributes the tasks associated with the GA kernels across a plurality (thousands) of GPU threads for simultaneous execution.

An execution platform 120 provides the physical computing environment and includes a plurality of GPUs 122 (such as Adreno GPUs) and a plurality of CPUs 124 (Snapdragon ARM platforms) for executing GA kernels using multithreading. The execution platform 120 provides hardware abstraction for kernel execution and resource management. The execution platform 120 executes the mathematically transformed workload with energy and cost optimization, thereby enabling the software system 100 to run efficiently and economically.

The software system 100 is optimized for commonly used processors such as Snapdragon ARM platforms with integrated Adreno GPUs, enabling high-throughput processing on energy-efficient hardware. Accordingly, the software system 100 reduces the high energy consumption of data processing and mitigates the environmental and economic impact of chip manufacturing by eliminating the requirement of custom-built, resource-intensive processors.

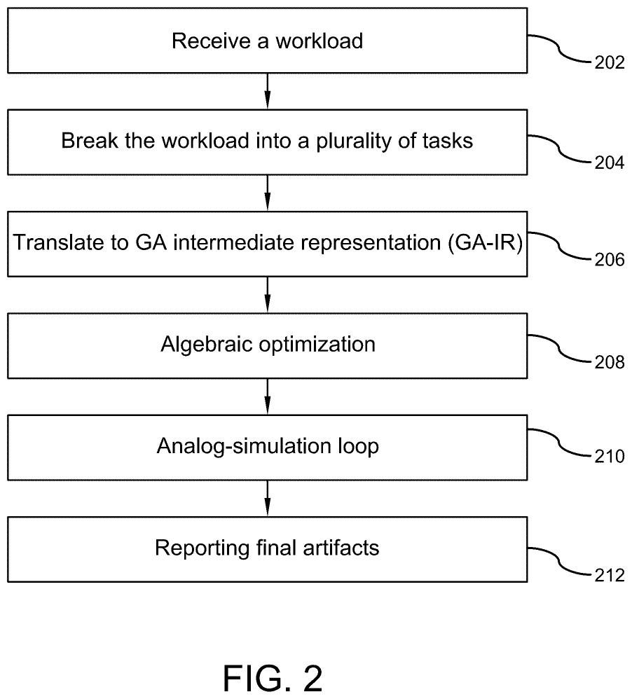

FIG. 2 illustrates a flowchart depicting a process for processing a workload using the GA-based analog supercomputer (i.e., analog computer) simulator software of the present invention in accordance with the disclosed architecture. Initially, the software system 100 receives an incoming computational workload (Step 202). The workload may be provided via an application programming interface (API), command-line interface, or graphical job submission interface and can include specifications for computational tasks, datasets, accuracy requirements, runtime constraints, and more. It should be noted that the software system 100 can validate the request and records job parameters for scheduling and resource allocation.

In the next step, the received workload is decomposed into smaller computational units, or tasks (Step 204). The breaking of the workload may involve determination of dependencies and parallelization between the tasks. The plurality of tasks may represent discrete data segments, iterative steps of simulation, or independent computations that can be run concurrently. It should be noted that each task can be associated with resource requirements, estimated execution time, and precision constraints.

Then, each task is converted into a geometric algebra intermediate representation (GA-IR) (Step 206). The conversion/translation replaces conventional complex-number or vector/matrix representations with multivector forms in GA (Step 206). The tasks are expressed in terms of GA operators (model “states”) acting on observables, consistent with Maxwell-equation formulations in geometric algebra terms.

Thereafter, the geometric algebra intermediate representation undergoes algebraic optimization and a set of optimized GA kernels are formed for execution (Step 208). In the next step, the optimized GA kernels are executed in the simulation layer which emulates the continuous-time operation of analog computers in a digital GPU environment (Step 210). In this step, multi-threaded GPU execution distributes workload segments across thousands of cores for high-throughput processing.

Finally, the results of the analog simulation are aggregated and prepared for delivery to the requesting application or user (Step 212). In preparing the final delivery, GA representations are decoded back into conventional numerical or symbolic formats and the software system 100 can maintain provenance data, including execution parameters and versioning.

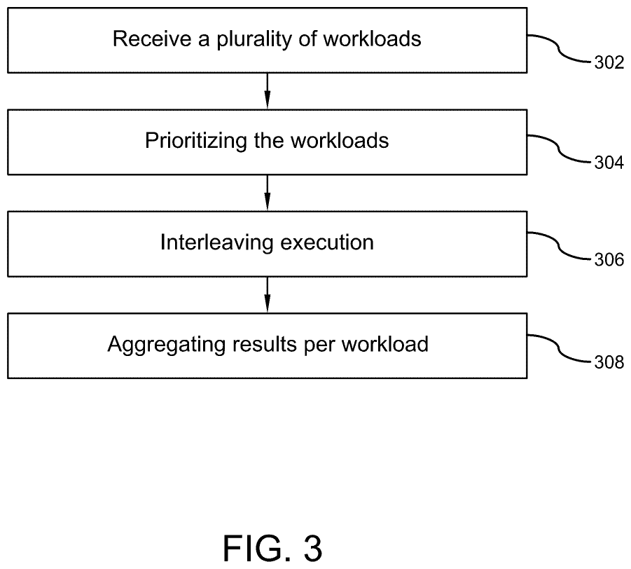

FIG. 3 illustrates a flowchart showing a process for executing multiple workloads concurrently within the GA-based analog supercomputer (i.e., analog computer) simulator system of the present invention in accordance with the disclosed architecture. Initially, the system receives a plurality of computational workloads (Step 302). The workloads may originate from different users, applications, or automated processes and each workload may have unique computational requirements, priority levels, deadlines, and energy usage constraints.

Then, the received workloads are prioritized according to a combination of factors, such as available GPU/CPU resources, execution deadlines and quality-of-service (QoS) levels of the workorders, and more (Step 304). Thereafter, the prioritized workloads are executed in an interleaved fashion within the analog-simulation loop/layer (Step 306) and GPU stream isolation techniques may be employed to prevent interference between workloads running simultaneously. The interleaving enables continuous progress on all workloads without idle time on processing units.

In step 308, the simulator system 100 aggregates the computation results independently for each workload and the results are assembled from their interleaved execution segments into complete datasets, simulations, or analytical outputs. The final results can be returned to the respective user or application, along with performance metrics and any requested telemetry.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “simulator system”, “GA-based analog supercomputer (i.e., analog computer) simulator software”, “analog supercomputer (i.e., analog computer) simulation software system”, and “analog supercomputer (i.e., analog computer) simulation system” are interchangeable and refer to the analog supercomputer (i.e., analog computer) simulation system 100 of the present invention.

Notwithstanding the forgoing, the analog supercomputer (i.e., analog computer) simulation system 100 of the present invention can be of any suitable configuration as is known in the art without affecting the overall concept of the invention, provided that it accomplishes the above stated objectives. One of ordinary skill in the art will appreciate that the analog supercomputer (i.e., analog computer) simulation system 100 as shown in the FIGS. are for illustrative purposes only, and that many other configurations of the analog supercomputer (i.e., analog computer) simulation system 100 are well within the scope of the present disclosure. Although the dimensions of the analog supercomputer (i.e., analog computer) simulation system 100 are important design parameters for user convenience, the analog supercomputer (i.e., analog computer) simulation system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An analog computer simulator system comprising:
a software system;
an application module; and
a geometric algebra (GA) engine;
wherein said software system comprises a simulation environment for running large-scale data-intensive applications;
wherein said application module comprises user-facing functionality for running multiple data workloads concurrently;
wherein said geometric algebra engine comprises a plurality of geometric algebra processes to model computations;
wherein said application module comprises an application runtime and scheduler configured to receive user jobs and to partition said user jobs into the group consisting of one or more of a plurality of parallel tasks, assign priorities, and assign quotas;
wherein said application module comprises manages ingress datasets, egress datasets, and stream adaptation of data in said software system;
wherein said ingress datasets are pre-processed, structured, and queued for geometric algebra (GA) transformation in said geometric algebra engine; and
further wherein said geometric algebra engine comprises a computational model to reformulate said ingress datasets from the group consisting of floating-points and complex-number mathematics into geometric algebra representations.

2. The analog computer simulator system of claim 1, wherein said geometric algebra representations are geometric algebra intermediate representations comprising said geometric algebra (GA) engine configured with geometric algebra multivectors.

3. The analog computer simulator system of claim 1, wherein said geometric algebra engine comprises a GA operator selected from the group consisting of a geometric product, an inner product, an outer product, and a state constructor configured to model operators acting on observables derived from Maxwell-equation formulations.

4. The analog computer simulator system of claim 3 further comprising a GA kernel compiler for lowering GA expressions into GPU-executable kernels.

5. The analog computer simulator system of claim 4, wherein said GA kernel compiler selects parallelization strategies from a system-on-chip (SoC) upon which said software system runs.

6. The analog computer simulator system of claim 5, wherein said geometric algebra (GA) engine replaces qubit entanglement logic with said GA operator.

7. The analog computer simulator system of claim 6, wherein said geometric algebra (GA) engine substitutes said GA multivectors for complex numbers.

8. The analog computer simulator system of claim 7 further comprising an analog-simulation layer to emulate continuous-time analog computations, wherein compiled GA kernels from said geometric algebra (GA) engine are passed to said analog-simulation layer.

9. The analog computer simulator system of claim 8 further comprising an analog kernel execution module to process said compiled GA kernels to emulate continuous mathematical systems and a parallel dispatcher to distribute tasks associated with said compiled GA kernels across a plurality of GPU threads for simultaneous execution.

10. A method for processing a plurality of ingress datasets using geometric algebra, the method comprising the steps of:
providing an analog computer simulator software, a software system, an application module, a geometric algebra (GA) engine, a GA kernel compiler, and an execution platform, wherein said execution platform comprises a plurality of GPUs and a plurality of CPUs;
lowering geometric algebra (GA) expressions with said GA kernel compiler into GPU-executable kernels;
wherein said GA kernel compiler selects parallelization strategies from a system-on-chip (SoC) upon which said software system runs;
wherein said software system comprises a plurality of geometric algebra processes to model computations;
wherein said software system comprises a simulation environment for running large-scale data-intensive applications;
wherein said application module comprises user-facing functionality for running multiple data workloads concurrently;
wherein said application module comprises an application runtime and scheduler configured to receive user jobs and to partition said user jobs into the group consisting of one or more of a plurality of parallel tasks, assign priorities, and assign quotas;
wherein said application module manages ingress datasets, egress datasets, and stream adaptation of data in said software system;
wherein said ingress datasets are pre-processed, structured, and queued for geometric algebra (GA) transformation in said geometric algebra engine; and
further wherein said geometric algebra engine comprises a computational model to reformulate said ingress datasets from the group consisting of floating-points and complex-number mathematics into geometric algebra representations.

11. The method for processing a plurality of ingress datasets using geometric algebra of claim 10, wherein said geometric algebra representations are geometric algebra intermediate representations comprising said geometric algebra (GA) engine configured with geometric algebra multivectors.

12. The method for processing a plurality of ingress datasets using geometric algebra of claim 10, wherein said geometric algebra engine comprises a GA operator selected from the group consisting of a geometric product, an inner product, an outer product, and a state constructor configured to model operators acting on observables derived from Maxwell-equation formulations.

13. The method for processing a plurality of ingress datasets using geometric algebra of claim 12, wherein said geometric algebra (GA) engine replaces qubit entanglement logic with said GA operator.

14. The method for processing a plurality of ingress datasets using geometric algebra of claim 13, wherein said geometric algebra (GA) engine substitutes said GA multivectors for complex numbers.

15. A method for processing a plurality of ingress datasets using geometric algebra, the method comprising the steps of:
providing an analog computer simulator software, a software system, an application module, a geometric algebra engine, a GA kernel compiler, and an execution platform, wherein said execution platform comprises a plurality of GPUs and a plurality of CPUs;
receiving an incoming computational workload of ingress datasets to said software system, wherein said ingress datasets are provided from a source selected from the group consisting of an application programming interface (API), a command-line interface, and a graphical job submission interface;
wherein said ingress datasets comprise specifications selected from the group consisting of computational tasks, datasets, accuracy requirements, and runtime constraints;
decomposing said ingress datasets into smaller computational tasks;
determining dependencies and parallelization between said computational tasks selected from the group consisting of discrete data segments, iterative steps of simulation, and independent computations that run concurrently;
converting each of said computational tasks into a geometric algebra intermediate representation (GA-IR);
replacing complex-number representations with multivector forms;
wherein each of said computational tasks are expressed in terms of GA operators and further wherein said GA operators selected from the group consisting of a geometric product, an inner product, an outer product, and a state constructor configured to model operators acting on observables derived from Maxwell-equation formulations.

16. The method for processing a plurality of ingress datasets using geometric algebra of claim 15, wherein said geometric algebra intermediate representation undergoes algebraic optimization and a set of optimized GA kernels are formed for execution.

17. The method for processing a plurality of ingress datasets using geometric algebra of claim 16, wherein said optimized GA kernels are executed in an analog simulation layer that emulates a continuous-time operation of analog computers in a digital GPU environment.

18. The method for processing a plurality of ingress datasets using geometric algebra of claim 17 further comprising the step of aggregating results of said analog simulation layer for delivery to a user.

19. The method for processing a plurality of ingress datasets using geometric algebra of claim 18 further comprising the step of decoding said geometric algebra intermediate representations back into conventional numerical formats.

20. The method for processing a plurality of ingress datasets using geometric algebra of claim 19, wherein said ingress datasets are selected from the group consisting of different users, different applications, and automated processes; and further wherein each of said ingress datasets comprises an operation selected from the group consisting of a unique computational requirement, a priority level, a deadline, and an energy usage constraint.
